(19) United States
(12) Patent Application Publication
(10) Pub. No.: US 2005/0047842 A1
(43) Pub. Date: Mar. 3, 2005

(54) Transporting apparatus, image forming apparatus and copier

(75) Inventor: Hiroshi Nobe, Nagoya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 10/930,860

(22) Filed: Sep. 1, 2004

(30) Foreign Application Priority Data
Sep. 2, 2003 (JP) 2003-310691

(51) Int. Cl. G03G 15/00

(52) U.S. Cl. 399/405

(57) ABSTRACT

A transporting apparatus has a transport path, a medium holding unit placed in an end of the transport path, the medium holding unit stackingly holding a medium transported along the transport path, and a charge removing unit disposed in the medium holding unit, the charge removing unit always butting against the medium that is stackingly held by the medium holding unit, thereby removing charges of the medium.

### BACKGROUND OF THE INVENTION

1. Field of the Invention

The present invention relates to a transporting apparatus in which medium holding units that holds media to be transported in ends of transport paths are vertically overlappingly placed, and also to an image forming apparatus and a copier having such a transporting apparatus.

2. Description of the Related Art

Recently, miniaturization of an image forming apparatus or a copier having a transporting apparatus including two or more transport paths are advancing. In many of such apparatuses, sheet ejection trays onto which media to be transported are to be ejected are vertically overlappingly placed. In order to reduce the size of such an apparatus, sheet ejection trays are placed so as to be vertically closer to each other. Transport paths for media to be transported are often formed into an S-like or U-like shape inside the apparatus. In order to realize miniaturization of the apparatus, the transport paths are configured so as to have a further reduced bending angle.

In such an apparatus, a medium to be transported is in sliding contact with a transport path, with the result that charges are easily accumulated in the medium to be transported. When a charged medium to be transported is ejected onto a sheet ejection tray, an attractive force due to an electrostatic force acts between the medium and a member such as another medium to be transported which is previously ejected, whereby a failure in stacking may be caused. JP-A-2003-87511 discloses a technique in which an antistatic brush is disposed in a transport path and in a position that is immediately before ejection of a medium to be transported (original) onto a sheet ejection tray (original ejection tray), and charges of the medium to be transported that is to be ejected onto the sheet ejection tray are discharged, thereby preventing a failure in stacking from occurring.

### SUMMARY OF THE INVENTION

During the ejecting process, when the medium to be transported which is to be ejected onto the sheet ejection tray is in sliding contact with another medium to be transported that is previously ejected, the medium to be transported may be charged. In the technique of JP-A-2003-87511, only when a medium to be transported is in contact with the antistatic brush, the medium to be transported can be discharged. After the medium to be transported has passed the antistatic brush, therefore, the medium to be transported cannot be discharged. As a result, as a larger number of media to be transported are stacked on the sheet ejection tray, the amount of charges of the whole stacked media to be transported is larger. In the case where plural sheet ejection trays are vertically overlappingly placed, media to be transported stacked on one sheet ejection tray may attract through the one tray other media to be transported stacked on another sheet ejection tray, and some of the other media to be transported on the other tray may rise to cause a failure in stacking. Such a failure may block a sheet ejection port to cause jamming.

The invention has been conducted in order to solve the problems. A transporting apparatus and an image forming apparatus and a copier having it are disclosed herein, in which a medium to be transported held by medium holding units can be always discharged.

According to an aspect of the invention, there is provided a transporting apparatus including: a transport path; a medium holding unit placed in an end of the transport path, the medium holding unit stackingly holding a medium transported along the transport path; and a charge removing unit disposed in the medium holding unit, the charge removing unit always butting against the medium that is stackingly held by the medium holding unit, thereby removing charges of the medium.

In this transporting apparatus, the charge removing unit always butts against the medium that is stackingly held by the medium holding unit, thereby discharging charges. Therefore, it is possible to prevent the charged medium from causing a failure when a next medium is transported to the medium holding unit to be held thereby.

According to another aspect of the invention, there is provided an image forming apparatus having: an image forming unit that forms an image on a medium; and a transporting apparatus that transports the medium on which the image is formed, the transporting apparatus including: a transport path; a medium holding unit placed in an end of the transport path, the medium holding unit stackingly holding the medium transported along the transport path; and a charge removing unit disposed in the medium holding unit, the charge removing unit always butting against the medium that is stackingly held by the medium holding unit, thereby removing charges of the medium.

In this image forming apparatus, since the charge removing unit always butts against the medium, it is possible to prevent a failure in stacking from occurring.

According to still another aspect of the invention, there is provided a copier having: an image forming unit that forms an image on a recording medium; a first transporting apparatus that transports the recording medium from the image forming unit, the first transporting apparatus further including: a first transport path; and a first medium holding unit placed in an end of the first transport path, the first medium holding unit stackingly holding the recording medium transported along the transport path; an image reading unit that reads an image formed on an original medium; and a second transporting apparatus that transports the original medium from the image reading unit, the second transporting apparatus further including: a second transport path; a second medium holding unit placed in an end of the second transport path in vertically overlapped manner with the first medium holding unit, the second medium holding unit stackingly holding the original medium transported along the second transport path; and a charge removing unit disposed in the second medium holding unit, the charge removing unit always butting against the original medium that is stackingly held by the second medium holding unit, thereby removing the charge of the medium.

In this copier, even when medium holding units are closely placed in order to reduce the size of the copier, it is possible to prevent a failure in stacking from occurring.

### BRIEF DESCRIPTION OF THE DRAWINGS

The present invention may be more readily described with reference to the accompanying drawings:

FIG. 1 is a central sectional view of a multi-functional apparatus;

FIG. 2 is a perspective view showing a state where an operation panel is detached, as viewing an image reading apparatus of the apparatus from a front obliquely upper side;

FIG. 3 is an enlarged section view showing main portions of the apparatus;

FIG. 4 is an enlarged sectional view showing main portions of a modification of the apparatus;

FIG. 5 is an enlarged sectional view showing main portions of another modification of the apparatus; and

FIGS. 6A and 6B are enlarged sectional views showing main portions of a modification of the apparatus.

### DETAILED DESCRIPTION OF THE PREFERRED EMBODIMENTS

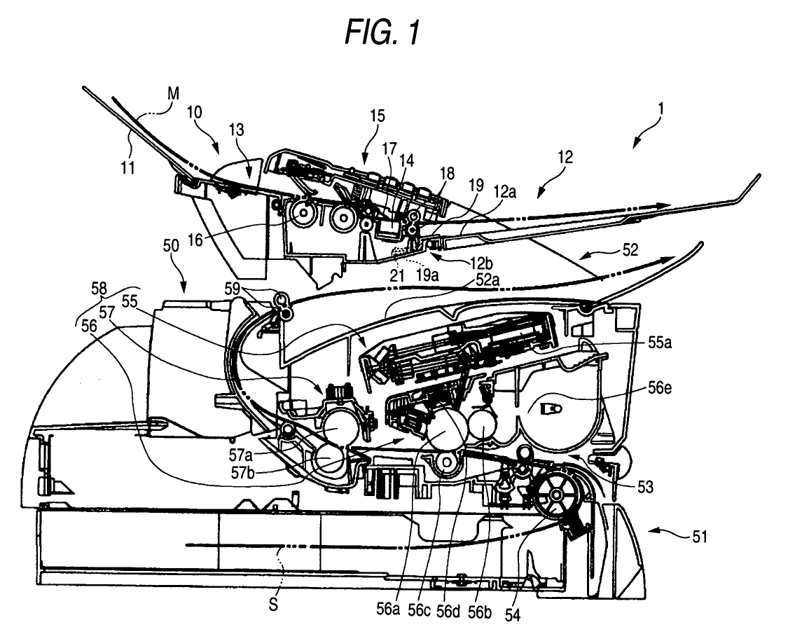

Hereinafter, an embodiment of a transporting apparatus, an image forming apparatus and a copier having such a transporting apparatus will be described with reference to the accompanying drawings and taking a multi-functional apparatus 1 in which the transporting apparatus is mounted, as an example. Referring to FIG. 1, first, the whole configuration of the apparatus 1 will be described. FIG. 1 is a central sectional view of the apparatus 1. In the figure, the rightward direction coincides with the front direction of the apparatus 1.

As shown in FIG. 1, the apparatus 1 having a copying function of reading an image of an original and printing the image onto a sheet has a configuration in which an image reading apparatus 10 for reading an image formed on a medium to be read is placed in an upper portion of a sectional view, and an image forming apparatus 50 for forming an image on a medium to be recorded is placed in a lower portion. The apparatus 1 further has a facsimile function which is not shown, and a modem, an NCU, and the like (not shown) which are known and used for transmitting an image read by the image reading apparatus 10 as FAX data to a terminal apparatus in a communication destination via a public communication network. The image forming apparatus 50 can print an image based on FAX data received from a terminal apparatus in a communication destination.

The image forming apparatus 50 is configured as a so-called laser printer, which is known. Ina substantially middle portion of the image forming apparatus 50, an image forming unit 58 which forms an image on a sheet serving as a medium to be recorded is disposed. A sheet supply cassette 51 which stackingly stores sheets is placed below the image forming unit 58, and a sheet discharge tray 52 onto which sheets bearing an image are discharged to be stackingly held. An S-like sheet transport path 53 is disposed in the image forming apparatus 50 so that a sheet picked up from the sheet supply cassette 51 is passed through the image forming unit 58, an image is formed on the sheet, and the sheet is then discharged onto the sheet discharge tray 52.

The sheet supply cassette 51 is attached to a bottom portion of the apparatus 1 so as to be attachable and detachable from the side of the front direction of the apparatus 1. A sheet supply roller 54 which feeds a sheet held in the sheet supply cassette 51 to the transport path 53 is disposed in the front face side of the apparatus 1 and above the sheet supply cassette 51. When a printing process is to be conducted, the sheet supply roller 54 picks up a sheet and then feeds the sheet in the front direction of the apparatus 1. In the vicinity of the sheet supply roller 54, the transport path 53 is formed into a U-like shape so that the sheet guided by the transport path 53 is directed toward the back face of the apparatus 1.

The image forming apparatus 50 is configured by: a laser unit 55 which emits a laser beam; a process unit 56 which forms a developer image by a developer such as a toner on the basis of the laser beam emitted from the laser unit 55 and which transfers the image onto the sheet; and a fixing unit 57 which fixes the image formed on the sheet by the process unit 56, onto the sheet.

In the laser unit 55, the laser beam emitted from a laser beam generating section which is not shown is scanned on the basis of print data in the main scanning direction (the direction perpendicular to the sheet transportation direction) by a rotated polygon mirror 55a, and the laser beam is transmitted or reflected by plural lenses and mirrors to exposure scan the surface of a photosensitive drum 56a of the process unit 56.

In the process unit 56, the photosensitive drum 56a, a developing roller 56b, a transfer roller 56c, a charging device 56d, and the like are disposed. The photosensitive drum 56a is a drum on the surface of which an invisible electrostatic latent image is formed by a potential difference. The surface of the photosensitive drum 56a is positively charged to a high potential (for example, +1,000V) by the charging device 56d which is disposed upstream in the rotational direction. The laser beam from the laser unit 55 illuminates the surface. In only the portion illuminated with the laser beam, the surface potential is lowered (for example, +100V). As a result, an electrostatic latent image is formed by high-potential and low-potential portions.

The developing roller 56b is disposed downstream in the rotational direction from the position of the photosensitive drum 56a which is exposed to the laser beam, charges a positively chargeable toner housed in a toner box 56e, and then supplies the charged toner to the photosensitive drum 56a on which the electrostatic latent image is formed. The developing roller 56b charges the toner to a potential (for example, +400 V) which is between the high and low potentials on the surface of the photosensitive drum 56a. At the position where the developing roller 56b is close to the photosensitive drum 56a, the toner carried by the developing roller 56b is selectively transferred to the low-potential portion of the photosensitive drum 56a.

The transfer roller 56c is placed downstream in the rotational direction of the photosensitive drum 56a from the developing roller 56b. A nip portion between the transfer roller and the photosensitive drum 56a is placed on the transport path 53 so that the sheet passes the portion. A bias is applied to the transfer roller 56c so that the potential of the roller is lower than that of the low-potential portion of the photosensitive 9′ drum 56a. Therefore, the developer image formed on the surface of the photosensitive drum 56a is electrostatically attracted by the transfer roller 56c from the rear side of the sheet passing the nip portion between the transfer roller and the photosensitive drum 56a, to be transferred onto the surface of the sheet.

The fixing unit 57 is configured by a heating roller 57a which gives heat of about 200 deg. to the sheet bearing a toner, thereby melting or softening the toner; and a pressure roller 57b which is urged so as to be pressed against the heating roller 57a. A nip portion between the heating roller 57a and the pressure roller 57b is placed on the transport path 53. When the sheet is passed through the nip portion, the toner on the sheet is heated and pressurized to be fixed to the sheet.

The transport path 53 is formed into a U-like shape in a position where the path has passed through the image forming unit 58, and guides the sheet to the sheet ejection tray 52 which is placed above the image forming unit 58. The sheet which is transported in the image forming unit 58 in the direction from the front face of the apparatus 1 to the back face is guided by the transport path 53 so that the transportation direction is directed to the front face of the apparatus 1, and then ejected onto the sheet ejection tray 52. A pair of sheet ejection rollers 59 are disposed in the tail end of the transport path 53. The bottom face 52a of the sheet ejection tray 52 in the upstream side of the transportation direction is disposed in a position which is lower in level than a nip portion of the sheet ejection rollers 59. The bottom face 52a of the sheet ejection tray 52 is upward inclined as advancing toward the front of the apparatus 1.

A transport path 13 which transports an original serving as a medium to be read in a direction from the back face of the apparatus 1 to the front face is disposed inside the image reading apparatus 10. A contact image sensor (hereinafter, abbreviated as “CIS”) 14 which reads the intensity of reflected light of light emitted from a light source (not shown) toward the original, and which digitizes the read intensity is disposed in the transport path 13. An original tray 11 which stackingly holds originals and supplies the originals to the transport path 13 is disposed at a start end of the transportation direction of the transport path 13. A sheet ejection tray 12 which stackingly holds originals that have been subjected to the image reading process and ejected from the transport path 13 is disposed at a tail end of the transport path. The sheet ejection trays 12, 52 function as medium holding units. The CIS 14 functions as an image reading unit.

A supply roller 16 is disposed in the start end of the transport path 13. An original held on the original tray 11 is picked up by the supply roller 16 to be fed into the transport path 13. An original pressing plate 17 is disposed above the CIS 14, and urged toward the CIS 14. When an original is passed above the CIS 14, the original is caused to be in close contact with the CIS 14 by the original pressing plate 17, so that the CIS 14 having a shallow depth of field can stably read an image without blurring. An operation panel 15 through which the apparatus 1 is operated is disposed in an upper portion of the image reading apparatus 10. A circuit board for detecting inputs of various buttons disposed on the operation panel 15 is placed above the transport path 13.

A pair of sheet ejection rollers 18 are disposed in the tail end of the transport path 13 to eject the original onto the sheet ejection tray 12. Also the bottom face 12a of the sheet ejection tray 12 in the upstream side of the transportation direction is disposed in a position which is lower in level than a nip portion of the sheet ejection rollers 18. The bottom face 12a of the sheet ejection tray 12 is upward inclined as advancing toward the front of the apparatus 1. The sheet ejection tray 12 can be detached from the image reading apparatus 10 while leaving a basal portion 12b which is disposed immediately below the sheet ejection rollers 18. An antistatic sheet 19 is disposed on an upper face of the basal portion 12b which constitutes a planar face continuous with the bottom face 12a of the sheet ejection tray 12.

In the apparatus 1 in which the image reading apparatus 10 and the image forming apparatus 50 are vertically arranged, in order to miniaturize the whole apparatus (to reduce the installation area), the sheet ejection tray 12 of the image reading apparatus 10 is positioned above the sheet ejection tray 52 of the image forming apparatus 50, and the trays are placed in vertically overlapping positions so as to be juxtaposed. In order to reduce the height of the apparatus, the distance between the sheet ejection trays 12, 52 is reduced as much as possible.

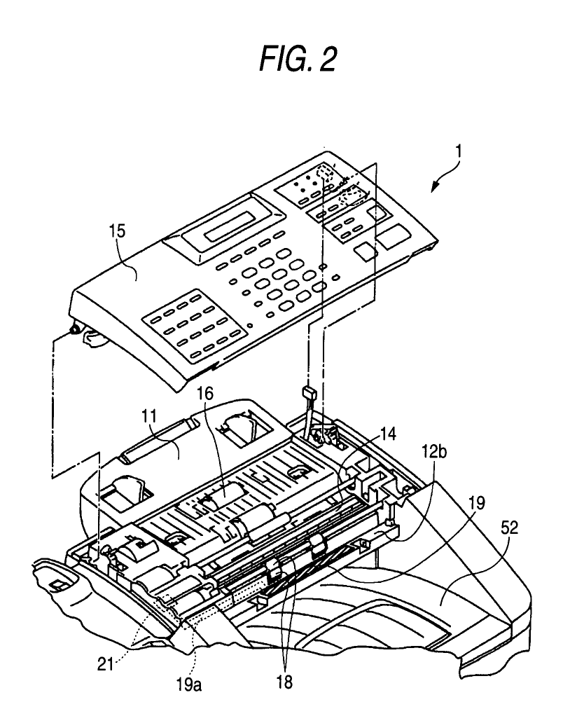

Next, the antistatic sheet 19 will be described with reference to FIG. 2. FIG. 2 is a perspective view showing a state where the operation panel 15 is detached, as viewing the image reading apparatus 10 of the apparatus 1 from a front obliquely upper side.

As shown in FIG. 2, in the state where the operation panel 15 is detached, the transport path 13 is exposed. The above-mentioned basal portion 12b of the sheet ejection tray 12 (see FIG. 1) is disposed below the sheet ejection rollers 18 which are disposed in the tail end of the transport path 13. The antistatic sheet 19 is disposed on the upper face of the basal portion 12b so as to be extended from the middle of the transport path 13 in the transportation width direction toward the both sides of the transportation width direction. This structure is employed because an original is transported along the transport path 13 while the middle in the transportation width direction coincides with the middle of the original in the width direction. The antistatic sheet 19 is placed so that, even when originals of different widths are transported, the originals are always caused to butt against the antistatic sheet.

The antistatic sheet 19 is configured by a thin film member that is electrically conductive, such as a copper foil. For example, an adhesive agent is applied to the rear face of the film, and the film is bonded to the upper face the basal portion 12b to be fixed thereto. The antistatic sheet 19 is grounded through a branch-like elongated portion 19a which is elongated from one end of the sheet to a grounding terminal 21 (see FIG. 1). The grounding terminal 21 is connected to a frame (not shown) of the apparatus 1 by a wire or the like which is not shown. The frame is configured so that the apparatus 1 is grounded through a grounding terminal for grounding to the outside of the apparatus 1. An original that is ejected from the sheet ejection rollers 18 falls on the bottom face 12a of the sheet ejection tray 12 which is lower in level than the rollers. The antistatic sheet 19 is placed so that the rear end of the original butts against the antistatic sheet 19. The antistatic sheet 19 and an antistatic brush 20 which will be described later function as a charge removing unit. The grounding terminal 21 which is connected to the frame, and to which the branch-like elongated portion 19a of the antistatic sheet 19 is connected functions as a grounding unit.

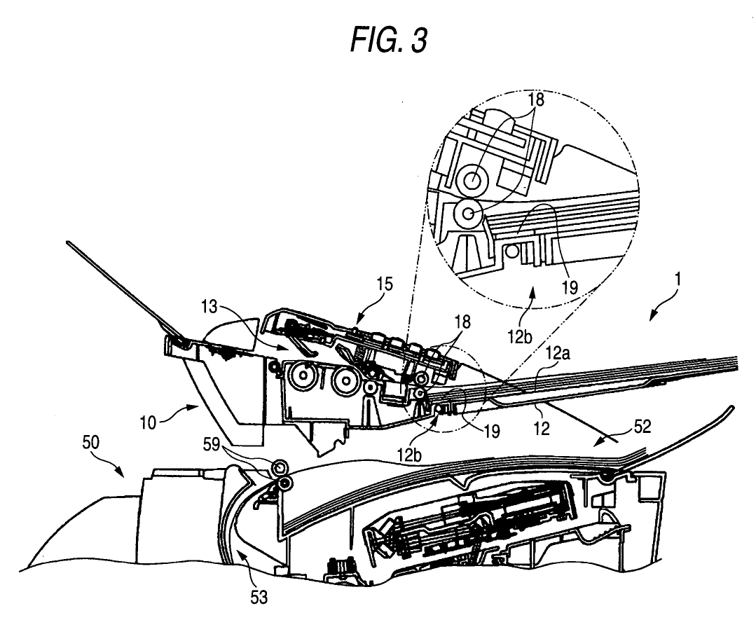

Next, an operation of discharging an original by the antistatic sheet 19 will be described with reference to FIG. 3. FIG. 3 is an enlarged sectional view showing main portions of the apparatus 1.

As shown in FIG. 3, sheets on which an image has been formed by the image forming apparatus 50 are stacked on the sheet ejection tray 52. In the printing process, a developer image is formed based on a potential difference, and the developer image is transferred onto a sheet, so that the sheet also is charged. When a sheet is transported from the process unit 56 to the fixing unit 57, therefore, the sheet is discharged by means of an antistatic needle which is not shown. However, a sheet which is ejected from the image forming unit 58 and then transported to the sheet ejection tray 52 with being guided by the U-like portion of the transport path 53 is transported with being in sliding contact with the transport path 53, and hence frictionally charged. In order to eliminate charges produced in the frictional charging, an antistatic brush which is not shown is disposed in the vicinity of the sheet ejection rollers 59 in the tail end of the transport path 53, so that the sheet is discharged also when it is ejected onto the sheet ejection tray 52.

When a sheet is ejected onto the sheet ejection tray 52, moreover, the ejected sheet is in sliding contact with sheets which are previously stacked. Also in this case, frictional charging occurs. Therefore, sheets which are stacked on the sheet ejection tray 52 are somewhat charged.

In the image reading apparatus 10, similarly, originals ejected onto the sheet ejection tray 12 are charged. An original is frictionally charged when it is transported in the transport path 13, or when it is in contact with originals which are previously stacked. In the embodiment, therefore, an original is discharged after it is ejected onto the sheet ejection tray 12. Specifically, an original which is to be ejected onto the sheet ejection tray 12 is caused to butt against the antistatic sheet 19.

As described above, the bottom face 12a of the sheet ejection tray 12 is upward inclined as advancing toward the front of the apparatus 1, i.e., in the direction of ejecting originals onto the sheet ejection tray 12. After the rear end of an original which is to be ejected onto the sheet ejection tray 12 has passed through the nip portion of the sheet ejection rollers 18 and the original receives no external force from the sheet ejection rollers 18, the original does not advance toward the front end of the sheet ejection tray 12 against the inclination of the bottom face 12a of the sheet ejection tray 12. Therefore, the original is held by the sheet ejection tray 12 in a state where the rear end of the original always butts against the antistatic sheet 19 which is bonded to the basal portion 12b of the sheet ejection tray 12.

An original which is next subjected to the image reading process overlaps with originals which are previously held by the sheet ejection tray 12. The original is frictionally charged during the transportation in the transport path 13. Since the bottom face 12a of the sheet ejection tray 12 is lower in level than the sheet ejection rollers 18, the front end of the portion of the original which is ejected from the sheet ejection rollers 18 hangs by its own weight to be in contact with an original which is previously held, and hence is frictionally charged. When the number of originals which are stacked on the sheet ejection tray 12 in this way becomes large, the whole originals which are stackingly held contain a large amount of charges.

In the embodiment, however, the charges are eliminated by the antistatic sheet 19. The lowest one of originals which are held by the sheet ejection tray 12 always butts against the antistatic sheet 19. Also originals which are stacked on the lowest original are always discharged through the lowest original, and therefore the originals which are stackingly held by the sheet ejection tray 12 are not charged. As a result, the uppermost one of the sheets held by the sheet ejection tray 52 of the image forming apparatus 50 is not attracted toward the sheet ejection tray 12 by an electrostatic force due to charges accumulated in the originals which are stackingly held by the sheet ejection tray 12.

In the apparatus 1, as described above, the antistatic sheet 19 is disposed in the sheet ejection tray 12 which is the upper one of the two sheet ejection trays 12, 52 that are vertically overlappingly placed. When an original is ejected onto the sheet ejection tray 12, the rear end of the original butts against the antistatic sheet 19 because the bottom face 12a of the sheet ejection tray 12 is upward inclined along the direction of ejecting the original, and the original is then held in a state where it always butts against the antistatic sheet. When the next subsequent originals which have been subjected to the image reading process are then stacked, also the originals are discharged through the lowest original.

It is a matter of course that the invention can be variously modified. The antistatic sheet 19 is a thin film member which is electrically conductive. Alternatively, the antistatic sheet may be a conductive thin sheet such as an iron sheet, and may have any configuration as far as grounding is conducted and it surely butts against an original ejected onto the sheet ejection tray 12.

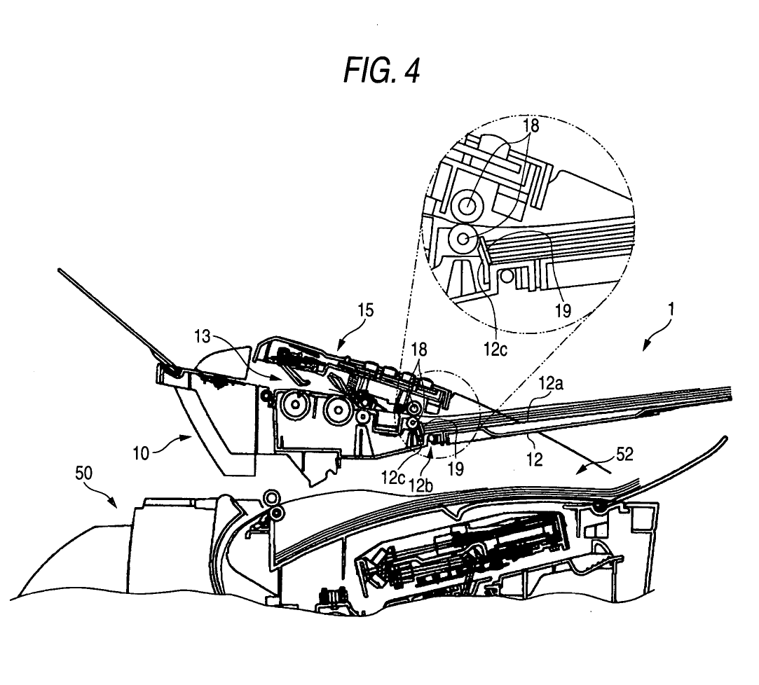

Alternatively, as shown in FIG. 4, the antistatic sheet 19 may be bonded to the rear wall face of the sheet ejection tray 12. As described above in the embodiment, the nip portion of the sheet ejection rollers 18 is placed in a position which is higher in level than the bottom face 12a of the sheet ejection tray 12. The antistatic sheet 19 is bonded to a wall face 12c between the basal portion 12b which is disposed immediately below the sheet ejection rollers 18, and which constitutes a planar face continuous with the bottom face 12a, and the sheet ejection rollers 18. Since the bottom face 12a is upward inclined along the direction of ejecting an original, an original ejected onto the sheet ejection tray 12 is caused to obtain a downward force in the inclination direction by its own weight. Since the wall face 12c is positioned in the downward tail end of the sheet ejection tray 12 in the inclination direction, originals which are held by the sheet ejection tray 12 butt against the wall face 12c. When the antistatic sheet 19 is bonded to the wall face 12c, therefore, it is possible to attain the same effects as those of the embodiment.

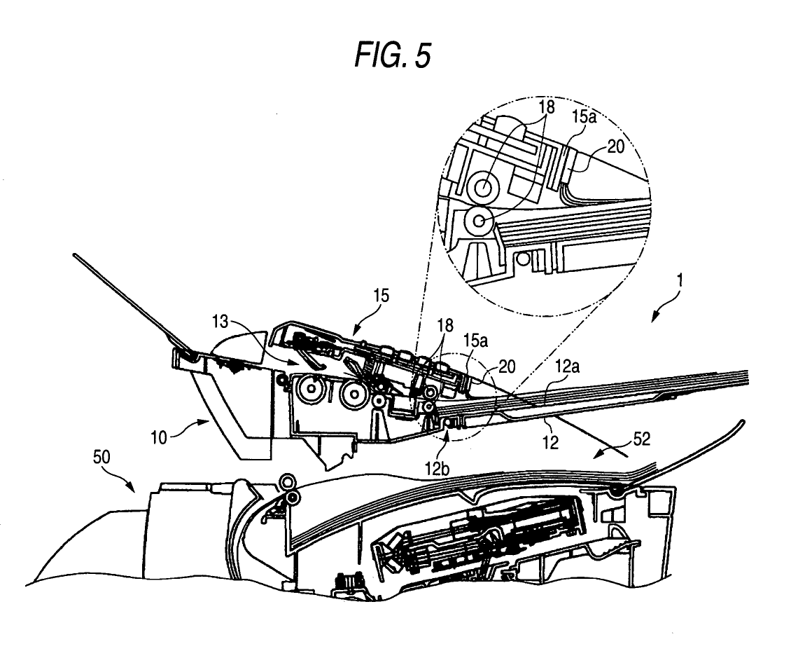

As shown in FIG. 5, the antistatic brush 20 may be disposed in place of the antistatic sheet 19. For example, the antistatic brush 20 is fixed to the front wall face 15a of the operation panel 15 so that, when the brush portion hangs toward the bottom face 12a of the sheet ejection tray 12, the tip end of the brush is in contact with the bottom face 12a. The antistatic brush 20 may be grounded, or may be configured by a brush which is self-dischargeable. When the thus configured antistatic brush 20 is disposed, an original which is ejected onto the sheet ejection tray 12 can be always in contact with the antistatic brush 20, and hence it is possible to attain the same effects as those of the embodiment.

In the embodiment, the multi-functional apparatus 1 has been described as an example. The configuration of the transporting apparatus of the embodiment can be adequately applied also to a copier which is not provided with a facsimile function, and to an image forming apparatus which does not have an image reading apparatus. Namely, the configuration of the transporting apparatus of the embodiment can be adequately implemented as a transporting apparatus for any image forming apparatus as far as sheet ejection trays for the image forming apparatus are formed as multiple stages so as to be selectively used in accordance with their purposes, and the sheet ejection trays are vertically overlappingly placed.

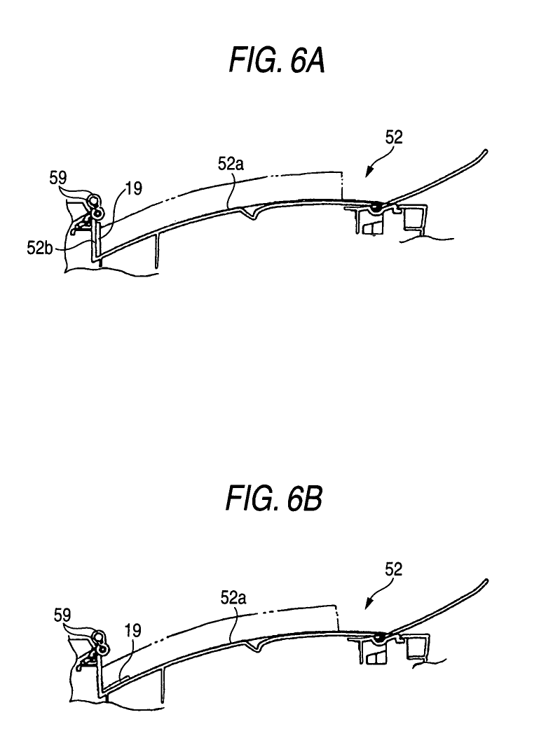

In the embodiment, the antistatic sheet 19 is disposed in the sheet ejection tray 12 which is the upper one of the two sheet ejection trays 12, 52 that are vertically overlappingly placed. Alternatively, an antistatic sheet or an antistatic brush may be disposed in the lower tray or the sheet ejection tray 52. FIG. 6A shows an example in which the antistatic sheet 19 is disposed on a vertical face 52a standing up from the bottom face 52a of the sheet ejection tray 52. FIG. 6B shows an example in which the antistatic sheet 19 is disposed on the bottom face 52a of the sheet ejection tray 52.

In the case where sheet ejection trays are placed in multiple stages, antistatic sheets or an antistatic brushes may be disposed in the all stages of sheet ejection trays. However, the configuration where an antistatic sheet or an antistatic brush is disposed in a part of sheet ejection trays is superior in cost and the like than that where it is disposed in all of sheet ejection trays. In the former configuration, preferably, an antistatic sheet or an antistatic brush is disposed in the upper one of the sheet ejection trays because a medium to be transported ejected onto the lower tray can be prevented from rising.

An antistatic sheet may be disposed over the whole bottom face of a sheet ejection tray. However, it is more preferable to dispose an antistatic sheet over a part of a sheet ejection tray from the viewpoints of the cost and the design. In this case, preferably, an antistatic sheet is disposed in the rear end side of a sheet ejection tray as in the embodiment because an ejected medium to be transported can always butt against the antistatic sheet. In a usual transporting apparatus, a sheet ejection port is often configured so as to be inconspicuous. When an antistatic sheet or an antistatic brush is disposed in the rear end side of a sheet ejection tray in the vicinity of a sheet ejection port, they can be made inconspicuous. Therefore, this configuration is preferable.

In the image reading apparatus 10, a CCD image sensor may be used in place of the CIS 14. The image forming apparatus 50 may be a known inkjet printer. The transport path 13 of the image reading apparatus 10 may be formed into a U-like shape, and the original tray 11 and the sheet ejection tray 12 may be vertically overlappingly placed.

According to the embodiment, the charge removing unit 19 is disposed on a bottom face 12a of the medium holding unit, and always butts against a medium to be transported which is the lowest one of the media to be transported that are stackingly held by the medium holding unit.

Therefore, charges of the media to be transported stackingly held by the medium holding unit can be discharged through the lowest medium to be transported. Therefore, it is not required to conduct a discharging operation on each of media to be transported.

Also, an antistatic brush 20 which is self-dischargeable may be employed as the charge removing unit.

In this case, the charge removing unit can be self-discharged, and hence is not necessary to be grounded. Therefore, the apparatus can be easily configured.

Further, the apparatus 1 has a grounding unit 21 connected to the charge removing unit, the grounding unit grounding the charge removing unit to discharge charges removed by the charge removing unit.

Therefore, the charge removing unit is grounded through the grounding unit 21, so that charges removed by the charge removing unit can be surely eliminated from the apparatus 1.

The charge removing unit is configured by an electrically conductive thin film member or by an electrically conductive thin plate.

Therefore, the amount of media to be transported which can be held by the medium holding unit is not reduced by the thickness of the charge removing unit, and the area by which the charge removing unit is in contact with the media to be transported can be increased. Therefore, charges of the media can be surely discharged.

According to the embodiment, the charge removing unit is disposed in a position where the charge removing unit is buttable against a proximity of a rear end of a medium to be transported in a transportation direction along which the medium to be transported is transported from the transport path to the medium holding unit.

Therefore, the charge removing unit is disposed in the vicinity of the rear ends of the media to be transported held by the medium holding unit. Even when the media to be transported have different sizes, the rear ends of the media in the transportation direction are positioned in a substantially same area on the medium holding unit. Therefore, charges of the media to be transported can be surely discharged.

Also, the medium holding unit is configured to cause a rear end side of the medium to be transported to be lower in level than a front side in the transportation direction along which the medium to be transported is transported from the transport path to the medium holding unit.

Therefore, the medium holding unit is upward inclined along the transportation direction of the media to be transported. Consequently, the rear ends of the media held by the medium holding unit are aligned with one another. Therefore, charges of the media can be surely discharged.

Further, the charge removing unit is disposed in an upper one of two medium holding units which are vertically overlappingly juxtaposed.

Therefore, it is possible to attain a state where charges of media to be transported held by the upper medium holding unit placed in the upper side are always discharged. Therefore, the uppermost one of the media held by the lower medium holding unit placed in the lower side is not upward attracted by an electrostatic force, and a failure in stacking can be prevented from occurring.

The invention can be applied to an image forming apparatus, a copier, or a facsimile apparatus having multiple sheet ejection trays which are vertically overlappingly placed, and also to a multi-functional apparatus having functions of these apparatuses.

While the invention has been described in conjunction with the specific embodiments described above, many equivalent alternatives, modifications and variations may become apparent to those skilled in the art when given this disclosure. Accordingly, the exemplary embodiments of the invention as set forth above are considered to be illustrative and not limiting. Various changes to the described embodiments may be made without departing from the spirit and scope of the invention.

1. A transporting apparatus comprising:
a transport path;
a medium holding unit placed in an end of the transport path, the medium holding unit stackingly holding a medium transported along the transport path; and
a charge removing unit disposed in the medium holding unit, the charge removing unit always butting against the medium that is stackingly held by the medium holding unit, thereby removing charges of the medium.

2. The transporting apparatus according to claim 1, wherein the charge removing unit is disposed on a bottom face of the medium holding unit, and always butts against the medium which is the lowest one of media that are stackingly held by the medium holding unit.

3. The transporting apparatus according to claim 1, wherein the charge removing unit comprises an antistatic brush that is self-dischargeable.

4. The transporting apparatus according to claim 1, further comprising:
a grounding unit connected to the charge removing unit, the grounding unit grounding the charge removing unit.

5. The transporting apparatus according to claim 4, wherein the charge removing unit is configured by an electrically conductive thin film member.

6. The transporting apparatus according to claim 4, wherein the charge removing unit is configured by an electrically conductive thin plate.

7. The transporting apparatus according to claim 1, wherein the charge removing unit is disposed in a position where the charge removing unit is buttable against a proximity of a rear end of the medium in a transportation direction along which the medium is transported from the transport path to the medium holding unit.

8. The transporting apparatus according to claim 7, wherein the medium holding unit is configured to cause a rear end side of the medium to be lower in level than a front side in the transportation direction along which the medium is transported from the transport path to the medium holding unit.

9. The transporting apparatus according to claim 7, wherein the charge removing unit extends in a direction substantially perpendicular to a surface direction of the medium held on the medium holding unit and is capable of contacting with the rear ends of media that are stackingly held on the medium holding unit.

10. The transporting apparatus according to claim 1, wherein the charge removing unit is disposed in an upper one of two medium holding units which are vertically overlappingly juxtaposed.

11. An image forming apparatus comprising:
an image forming unit that forms an image on a medium; and
a transporting apparatus that transports the medium on which the image is formed, the transporting apparatus including:
a transport path;
a medium holding unit placed in an end of the transport path, the medium holding unit stackingly holding the medium transported along the transport path; and
a charge removing unit disposed in the medium holding unit, the charge removing unit always butting against the medium that is stackingly held by the medium holding unit, thereby removing charges of the medium.

12. A copier comprising:
an image forming unit that forms an image on a recording medium;
a first transporting apparatus that transports the recording medium from the image forming unit, the first transporting apparatus further comprising:
a first transport path; and
a first medium holding unit placed in an end of the first transport path, the first medium holding unit stackingly holding the recording medium transported along the transport path;
an image reading unit that reads an image formed on an original medium; and
a second transporting apparatus that transports the original medium from the image reading unit, the second transporting apparatus further comprising:
a second transport path;
a second medium holding unit placed in an end of the second transport path in vertically overlapped manner with the first medium holding unit, the second medium holding unit stackingly holding the original medium transported along the second transport path; and
a charge removing unit disposed in the second medium holding unit, the charge removing unit always butting against the original medium that is stackingly held by the second medium holding unit, thereby removing the charge of the medium.
